(19) United States
(12) Patent Application Publication
(10) Pub. No.: US 2013/0328982 A1
(43) Pub. Date: Dec. 12, 2013

(54) INK JET DEVICE COMPRISING FLUID EXTRACTION MEANS, AND ASSOCIATED INK JET METHOD

(71) Applicants: Norbert Fabre, Lavaur (FR); Véronique Conedera, Toulouse (FR); Paul Fadel, Toulouse (FR); Fabien Mesnilgrente, Toulouse (FR)

(72) Inventors: Norbert Fabre, Lavaur (FR); Véronique Conedera, Toulouse (FR); Paul Fadel, Toulouse (FR); Fabien Mesnilgrente, Toulouse (FR)

(73) Assignee: INK JET DEVICE COMPRISING FLUID EXTRACTION MEANS AND ASSOCIATED INK JET METHOD, Paris (FR)

(21) Appl. No.: 13/993,426

(22) PCT Filed: Nov. 24, 2011
(86) PCT No.: PCT/IB2011/055286

§ 371 Date: Sep. 3, 2013

(30) Foreign Application Priority Data
Dec. 13, 2010 (FR) 1004848

(51) Int. Cl. B41J 2/17

(52) U.S. Cl. CPC B41J 2/17
USPC 347/102

(57) ABSTRACT

The invention relates to an ink jet device and to an associated ink jet method. The ink jet device comprises at least one ink jet head (10) mounted on a support (20), characterised in that the support (20) comprises at least one opening (30, . . . , 3n,) arranged around said at least one head, said opening being fluidically connected to a means (40) for triggering the movement of a fluid to be extracted via said opening.

The present invention relates to inkjet printing techniques.

Inkjet printing techniques are especially used in the field of printers and, more generally, in graphic applications.

At the present time it is desired to apply inkjet printing techniques to fields other than graphic design, such as, for example, to microtechnology and/or nanotechnology.

This is because known inkjet printing devices are inexpensive and reliable. It would therefore be desirable to be able to benefit from these advantages in fields other than that of graphic applications.

However, certain applications have specific needs that known inkjet printing devices are not able to meet.

Thus, in the nanotechnology field, the use of known inkjet printing devices is confronted with safety problems. These safety problems may relate to the size of the nanoparticles and/or to the nature of the solvent employed in the ink. The deposited ink comprises a mixture of nanoparticles and solvent, this ink for example being intended to be deposited on a substrate.

Inkjet printing techniques are also confronted with problems relating to their resolution relative to the resolution of the techniques, such as photolithography, conventionally used in this field. Specifically, known inkjet printing devices do not allow ink to be deposited on a substrate with a write quality that is as precise as that obtained with the techniques conventionally used in the field of nanotechnology.

Similar problems are also encountered in the microtechnology field.

One objective of the invention is to provide an inkjet printing device capable of obtaining, in particular in fields other than graphic applications, such as in microtechnology and/or nanotechnology, a better resolution than existing inkjet printing devices.

Another objective of the invention is to provide an inexpensive and reliable inkjet printing device.

Another objective of the invention is also to improve the operating safety of such a device.

To achieve at least one of these objectives, the invention provides an inkjet printing device comprising at least one inkjet head mounted on a supporting member, characterized in that the supporting member comprises at least one orifice placed around said at least one head, this orifice being fluidically connected to a means for setting a fluid intended to be extracted from this orifice in motion.

The device will possibly have other technical features, whether in isolation or in combination:
said at least one orifice encircles said at least one inkjet head;
the device comprises a plurality of orifices placed around said at least one inkjet head;
the device comprises a plurality of inkjet heads mounted on the supporting member;
the supporting member comprises a plurality of orifices placed around each of the inkjet heads of said plurality of heads;
the respective centers of each of the orifices are placed in a circle the center of which is that of the inkjet head;
the orifices are placed at regular intervals;
the orifices are identical;
the orifices have conical openings;
the device comprises a fluid extraction chamber placed between said at least one orifice and the means for setting said fluid in motion; and
the device comprises a means for heating a target surface on which the ink is intended to be deposited.

To achieve at least one of these objectives, the invention also provides an inkjet printing process for printing on a target surface, characterized in that it comprises the following steps:
depositing ink on the target surface using at least one inkjet head mounted on a supporting member, said ink comprising a solvent that is liable to evaporate when it makes contact with the target surface; and
extracting a fluid containing solvent vapors by way of at least one orifice placed around the inkjet head, this orifice being fluidically connected to a means for setting said fluid in motion.

The process may also make provision for the target surface to be heated.

Other features, aims and advantages of the invention will become apparent from the following detailed description given with reference to the following figures:

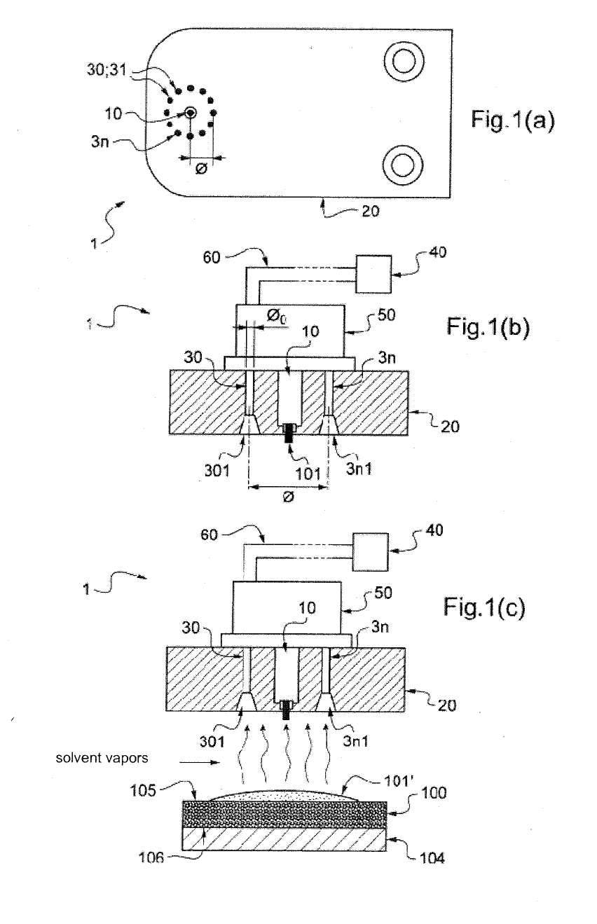

FIG. 1(a) shows a bottom view of a first embodiment of an inkjet printing device according to the invention;

FIG. 1(b) shows a cross-sectional view of the inkjet printing device shown in FIG. 1(a);

FIG. 1(c) shows an assembly comprising the inkjet printing device shown in FIG. 1(b) above a target surface on which ink is deposited;

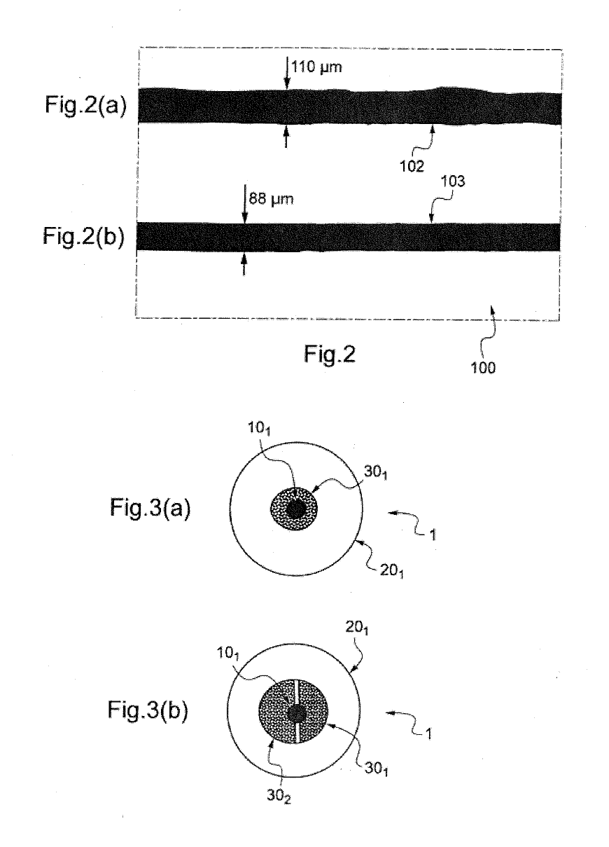

FIG. 2, which comprises FIGS. 2(a) and 2(b), presents results comparing the deposition of a line of ink on a target surface with the device according to the invention, on the one hand, in FIG. 2(a), without extraction of the fluid contained between the inkjet head and the target surface, and on the other hand, in

FIG. 2(b), while extracting the fluid between this inkjet head and the target surface;

FIG. 3(a) shows a bottom view of a second embodiment of an inkjet printing device according to the invention, comprising an inkjet head encircled by a fluid extraction orifice;

FIG. 3(b) shows a bottom view of a variant of the second embodiment shown in FIG. 3(a);

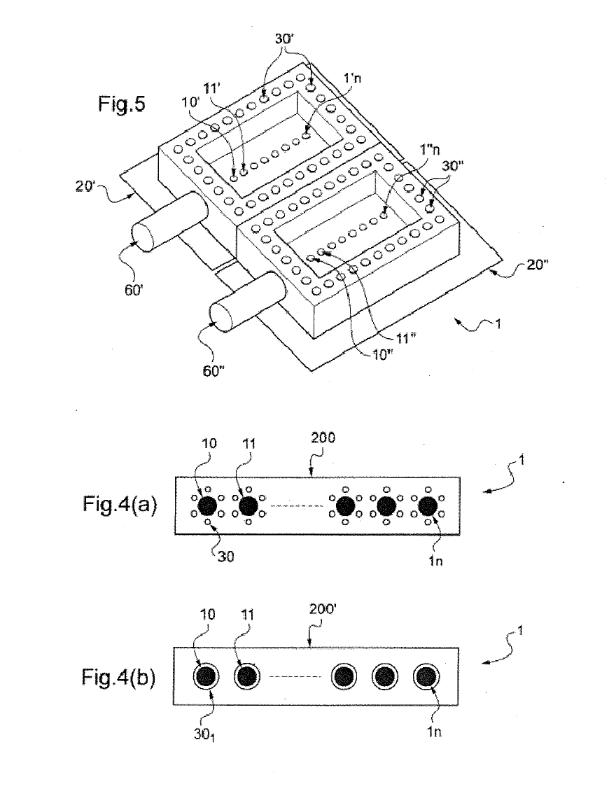

FIG. 4(a) shows a bottom view of a third embodiment of an inkjet printing device according to the invention, comprising a plurality of inkjet heads, in which a plurality of fluid extraction orifices encircle each inkjet head according to the first embodiment presented with reference to FIGS. 1(a) and 1(b);

FIG. 4 (b) shows a bottom view of a variant of the third embodiment of an inkjet printing device according to the invention, comprising a plurality of inkjet heads, in which a fluid extraction orifice encircles each inkjet head according to the second embodiment shown in FIG. 3(a); and

FIG. 5 shows a perspective bottom view of a fourth embodiment of an inkjet printing device comprising, as in FIG. 3, a plurality of inkjet heads.

A first embodiment is shown in FIGS. 1(a) to 1(c).

The inkjet printing device 1 comprises at least one inkjet head 10 mounted on a supporting member 20. In these figures, the inkjet printing device 1 comprises only a single head 10. This head 10 terminates in an ink ejection nozzle 101.

The inkjet printing device 1 also comprises fluid extraction orifices 30, 31, . . . , 3n placed around the head 10, namely in the space surrounding this head. The respective centers of each of the orifices 30, 31, . . . , 3n are moreover placed a distance away from the longitudinal axis of the head 10.

These orifices are produced in the member 20 supporting the inkjet head 10 and pass through this member. They each comprise an opening 301, 3n1 placed, with respect to the supporting member 20, on the same side as the nozzle 101. This arrangement allows the fluid contained in the volume located between the supporting member 20 and a target surface 100 on which the ink is intended to be deposited, to be removed, as will be explained in more detail below.

These orifices 30, 31, . . . , 3n are also associated with a means 40 for setting said fluid in motion, by way of a fluidic connection.

The means 40 for setting the fluid in motion is generally a pump. A pump especially allows the motion of the fluid to be forced (forced convection).

The fluid is thus sucked from an opening 301, 3n1, into the orifice itself, in order to be extracted.

The fluidic connection moreover comprises a fluid extraction chamber 50 placed between the fluid extraction orifices 30, 31, . . . , 3n and the means 40 for setting said fluid in motion, and a duct 60 placed between the fluid extraction chamber 50 and the means 40 for setting said fluid in motion.

For microtechnology or nanotechnology applications, the fluid in question may be a mixture of a fluid such as air and solvent vapors.

Specifically, the ink used for these applications may be formed by a mixture of a powder, microparticles or nanoparticles depending on the circumstances, and a solvent. Moreover, the volume located between the supporting member 20 and the target surface 100 is generally filled with air. The target surface 100 is in this case a substrate, for example made of silicon, especially liable to be used in the nanotechnology field.

Thus, when a drop 101′ of ink is deposited on the surface of the substrate 100, as shown in FIG. 1(c), the solvent contained in the drop evaporates in order to leave only the desired deposit, solvent vapors then mixing with the fluid contained in the volume separating the supporting member 20 and the substrate 100.

The rapidity of the evaporation of the solvent is an important factor affecting whether the desired deposit on the substrate can be rapidly formed, and therefore whether this deposit is inexpensive and has a good resolution.

Thus, extracting the fluid prevents accumulation of solvent vapors in this space located between the inkjet head 10 and the substrate 100, thereby, as will be explained below, promoting evaporation of the solvent.

For the same purpose, the device 1 preferably comprises a means 104 for heating the substrate 100, generally placed on that side 106 of the substrate 100 which is opposite that side 105 of said substrate 100 on which the ink 101′ is deposited, as is shown in FIG. 1(c). This is because heating accelerates evaporation of the solvent.

Extraction of the solvent vapors improves safety, insofar as these vapors may be toxic. Specifically, it is not necessary, in the context of the invention, to house the assembly formed by the inkjet printing device 1 and the substrate 100 in a closed sealed chamber. Extraction of the fluid must not disturb the jet of ink between the head 10 and the substrate 100. For this reason the fluid extraction flow rate is generally between 0.1 l/mn and 0.6 l/mn, and preferably between 0.2 l/mn and 0.5 l/mn with the device shown in FIGS. 1(a) to 1(c).

The distribution of the orifices 30, 31, . . . , 3n around the inkjet head 10, and their respective diameters and/or the distance between their respective centers and the longitudinal axis of the head 10 may vary, provided that the jet of ink is not disturbed.

For example, the orifices 30, 31, . . . , 3n may have an identical diameter and these orifices 30, 31, . . . , 3n may be regularly distributed around the inkjet head 10 so that the fluid is extracted uniformly from around the inkjet head.

More precisely, in the example shown in FIGS. 1(a) to 1(c) the respective centers of each of the fluid extraction orifices 30, 31, . . . , 3n are placed at regular intervals in a circle the center of which is that of the inkjet head 10.

In this example, the diameter Φ of this circle is 9.5 mm and the diameter Φₒ of each of the orifices is about 2 mm. Under these conditions, more than about ten orifices may be placed around the inkjet head 10. The diameter Φ is shown in FIG. 1(a) and the diameter Φₒ is shown in FIG. 1(b).

The orifices 30, 31, . . . , 3n preferably comprise a conical opening 301, 3n1, this cone narrows in the direction from the zone where fluid enters into the orifice, to the interior of the orifice. Thus, turbulent motion or rotation of the fluid at the inlets of the orifices 30, 31, . . . , 3n is limited, which turbulent motion or rotation could possibly disturb the inkjet.

A cylindrical opening 301, 3n1, the diameter of which is identical to that of the orifice in its entirety, could be envisioned.

The device 1 according to the invention also allows the resolution of the deposit of ink obtained on the substrate 100 to be improved relative to known inkjet printing devices.

FIGS. 2(a) and 2(b) show lines of ink deposited on a substrate, which deposits are produced using the device described with reference to FIGS. 1(a) to 1(c), without fluid extraction and with fluid extraction, respectively.

The other test conditions are identical.

More particularly, the following conditions are the same for both tests.

The ink is formed from a mixture of zinc oxide nanoparticles in a concentration by weight of 10% in the solvent, namely ethylene glycol, and 1% by weight of a surfactant, in this case TRITON X100. The same amount of ink is deposited.

The ejection nozzle 101 used has a diameter of 50 Am and the temperature of said nozzle is 50° C. The voltage of the piezoelectric actuator is set to 40 volts, on account of the inkjet head used.

The nozzle is moved relative to the substrate at a speed of 450 μm/s.

The speed of descent of the ink drops delivered from the nozzle to the substrate 100 is about 3 m/s.

A line is formed by depositing drops in succession every 20 μm.

The distance separating the nozzle from the substrate is about 1 mm. The contact angle between an ink drop deposited on the substrate and the substrate is 15°.

The temperature of the substrate is kept at 105° C.

It may be seen from FIG. 2(a), in the absence of any fluid extraction, that the line 102 of ink deposited on the substrate 100 has an average width of 110 μm and that the edges of this line are not straight.

In contrast, as may be seen in FIG. 2(b), with fluid extraction, a narrower (88 μm) line 103 is obtained, the edges of which are moreover straighter. The fluid extraction flow rate is in the present case 0.5 l/mn.

The extraction of fluid, and more precisely of ethylene glycol vapors, therefore makes it possible to increase the resolution of the deposit. In the present case, the resolution is improved by about 20%.

The inventors consider that the extraction of fluid from the space located between the inkjet head 10 and the substrate on which the ink drop is deposited, creates a vacuum that might allow the rate of evaporation of the solvent contained in the ink to be increased. The ink deposited on the substrate 100 might thus have less time to spread over the substrate, which could explain the obtained increase in resolution of 20%.

It could be envisioned to obtain a line of ink of similar width to the width of the line of ink shown in FIG. 2(b) without fluid extraction.

However, to obtain this result the temperature of the substrate would have to be increased from 105° C. to a higher value, generally between 110° C. and 115° C., in the case where the solvent is ethylene glycol. It will be understood that at higher temperatures the rate at which the solvent evaporates increases, thereby possibly resulting in the line of ink deposited having a better resolution.

Unfortunately, it has been observed that if the temperature of the substrate is too high, the line of ink deposited may become nonuniform, exhibiting voids and irregularities.

In contrast, fluid extraction allows the resolution of the line of ink deposited to be increased while decreasing the heating temperature of the substrate. The use of materials that cannot withstand temperatures as high as 115° C. without deforming mechanically or suffering modifications to their internal chemical structures may therefore be envisioned.

The first embodiment, shown in FIGS. 1(a) to 1(c), comprises just one inkjet head surrounded by a plurality of extraction orifices.

A bottom view of a second embodiment of the inkjet printing device 1 is shown in FIG. 3(a).

The inkjet printing device 1 comprises a single inkjet head equipped with an ink ejection nozzle, around which a fluid extraction orifice 30₁ is produced in the member 20₁ supporting the device. The orifice 30₁ passes through the supporting member 20₁.

The fluid extraction orifice 30₁ is therefore actually placed around the inkjet head. More precisely, the inkjet head 10₁ is encircled by the fluid extraction orifice 30₁.

The extracted fluid thus flows around the perimeter of the inkjet head 10₁.

Preferably, the orifice has an annular shape, the center of the ring thus formed coinciding with the longitudinal axis of the nozzle 10₁ so that this longitudinal axis forms an axis of symmetry of the orifice 30₁.

The fluid extracted via the orifice 30₁ encircling the ink ejection nozzle 10₁ does not disturb the jet of ink. The inventors consider that this is due to the fact that the flow rate of the extracted fluid generally does not exceed 0.5 l/mn.

A conical orifice opening (not shown) may however be provided in order to limit any possible risk of disturbing the inkjet.

An experimental test (not reported) was carried out with the configuration shown in FIG. 3(a), under identical conditions to those described above for the device shown in FIGS. 1(a) to 1(c), which test allowed the relevance of this second embodiment to be demonstrated.

In a variant of this second embodiment, illustrated in FIG. 3(b), a plurality of independent orifices 30₁, 30₂ may be provided encircling the inkjet head. These orifices 30₁, 30₂ then pass through the supporting member 20. For example, if two orifices of this type are provided, each orifice may have, in cross section, a half-ring shape, as is shown in FIG. 3(b). More than two orifices of this type may be provided.

Other embodiments employing a plurality of inkjet heads are described below with reference to FIGS. 4(a), 4(b) and 5.

A third embodiment is shown in FIG. 4(a) and a variant of this third embodiment is shown in FIG. 4(b).

The inkjet printing device 1 here comprises a plurality of inkjet heads 10, 11, . . . , in mounted on a supporting member 200, 200′. The supporting member comprises at least one fluid extraction orifice around each of the inkjet heads of said plurality of heads 10, 11, . . . , 1n. Said at least one orifice extends through said supporting member 200, 200′.

In FIG. 4(a), the arrangement, the number and/or the size, with respect to the diameter of the orifices around a given inkjet head, may be identical to the arrangement, the number and/or the size of the orifices described with reference to FIGS. 1(a) to 1(c). The orifices of multi-nozzle heads are, in general, smaller. In FIG. 4(a) one of the orifices placed around the first inkjet head 10 of the plurality of heads is indicated by the reference number 30.

In FIG. 4(b), each inkjet head is encircled by a single orifice, as described with reference to FIG. 3(a). Thus, in FIG. 4(b), the reference 30₁ denotes an orifice encircling the inkjet head 10₁.

A fourth embodiment is shown in FIG. 5.

In this embodiment, it may be envisioned for the inkjet printing device 1, comprising a plurality of inkjet heads 10′, 11′, . . . , 1n′ (or 10″, 11″, . . . , 1n″), to comprise a supporting member 20′ (or 20″) having a plurality of fluid extraction orifices 30′ (or 30″) placed around all of the inkjet heads.

In this variant, there is thus no longer a plurality of orifices placed around each inkjet head (FIG. 4(a)), but a plurality of orifices placed around an array of inkjet heads.

In this variant, the solvent could be extracted at a faster rate without disturbing the jet.

The entrances of the orifices 30′, 30″ may be placed at a similar height to that of the ejection nozzle of each inkjet head in a similar way to the embodiment shown in FIGS. 1(a) to 1(c).

Preferably, and as shown in FIG. 5, it may be envisioned to place the inlets of the orifices 30′, 30″ in a plane shifted relative to the ejection nozzles of the inkjet heads. The orifices 30′, 30″ are then closer to the target surface (not shown) on which the ink is deposited than the inkjet heads are. This solution is even more certain to prevent disturbance of the jet of ink delivered from each of the inkjet heads.

The diameter of the orifices is preferably identical. Moreover, the orifices are preferably regularly distributed around the array of inkjet heads.

In this variant, the supporting member 20′, 20″ may incorporate an extraction chamber (not referenced) between the orifices and the means (not referenced) for setting the fluid in motion. As in the other variant embodiments, a duct 60′, 60″ is provided by way of a fluidic connection between the orifices, or more precisely the chamber, when the latter is provided, and the means for setting the fluid in motion. The orifices 30′, 30″ thus pass through the associated supporting member 20′, 20″ in order to exit via the associated duct 60′, 60″.

Lastly, it should be noted that the embodiment shown in FIG. 4 may also apply to a single head equipped with a plurality of ink ejection nozzles.

Finally, the device according to the invention has many advantages over known devices.

One advantage is that it is possible to print ink on cooler target surfaces i.e. on target surfaces at lower temperatures.

It is thus possible to print on substrates made of polymers that cannot withstand high temperatures, while maintaining the resolution of the deposit obtained.

It is also possible to print materials, diluted in the solvent of the ink, that cannot withstand high temperatures, such as inks comprising biological compounds.

Moreover, this substrate temperature saving limits the cost of manufacturing and using the device.

In particular, in the field of nanotechnology or microtechnology, manufacture of the substrate carrier is made easier and the precision of its alignment is increased because thermal expansion of the latter is limited.

In addition, the lifetime of surface treatments liable to be produced on the substrate is increased. Specifically, when it is desired to deposit ink on an area smaller than the diameter of a drop, a hydrophobic region is generally defined around this area with octadecyltrichlorosilane by photolithography. The deposited drops are then confined to the area inside the hydrophobic zone. However, the lifetime of this hydrophobic treatment is highly dependent on the operating temperature of the substrate. The lower the temperature of the substrate, the longer the lifetime of the treatment.

Another advantage relates to the increase in resolution of the deposit thus obtained.

Specifically, the device according to the invention allows the resolution of a line of ink deposited on a target surface to be substantially increased relative to known devices, and for lower temperatures of this target surface.

Moreover, it is possible to choose nozzles having larger diameters than known nozzles, in order to prevent problems with clogging, without decreasing resolution.

Another advantage relates to the increased range of inks compatible with the inkjet printing device.

The use of such inks, having high boiling points, decreases the risk of clogging of the nozzles during phases in which the inkjet printing device is stopped and restarted.

1. An inkjet printing device comprising at least one inkjet head (10, 10′, 11′, . . . , 1′n, 10″, 11″, . . . , 1″n) mounted on a supporting member (20, 20₁, 20′, 20″, 200), characterized in that the supporting member (20, 20₁, 20′, 20″, 200) comprises at least one orifice (30, 31, . . . , 3n, 30₁, 30₂, 30′, 30″) placed around said at least one head, this orifice being fluidically connected to a means (40) for making evaporation of the solvent contained in the ink more rapid by setting a fluid intended to be extracted from this orifice in motion.

2. The inkjet printing device as claimed in claim 1, in which said at least one orifice (30₁, 30₂) encircles said at least one inkjet head.

3. The device as claimed in claim 1, in which a plurality of orifices are provided placed around said at least one inkjet head.

4. The inkjet printing device as claimed in claim 1, in which a plurality of inkjet heads (10, 11, . . . , 1n, 10′, 11′, . . . , 1′n, 10″, 11″, . . . , 1″n) are mounted on the supporting member.

5. The inkjet printing device as claimed in claim 4, in which the supporting member (200) comprises a plurality of orifices placed around each of the inkjet heads of said plurality of heads (10, 11, . . . 1n).

6. The inkjet printing device as claimed in claim 3, in which the respective centers of each of the orifices (30, 31, . . . , 3n) are placed in a circle the center of which is that of the inkjet head.

7. The device as claimed in claim 6 in which the orifices (30, 31, . . . , 3n) are placed at regular intervals.

8. The device as claimed in claim 6 in which the orifices (30, 31, . . . , 3n) are identical.

9. The inkjet printing device as claimed in claim 1 in which the orifices (30, 31, . . . , 3n) have conical openings (301, 3n1).

10. The inkjet printing device as claimed in claim 1, in which a fluid extraction chamber (50) is provided placed between said at least one orifice and the means (40) for setting said fluid in motion.

11. The inkjet printing device as claimed in claim 1, in which a means (103) is provided for heating the target surface (100) on which the ink is intended to be deposited.

12. An inkjet printing process for printing on a target surface (100), characterized in that it comprises the following steps:
depositing ink on the target surface using at least one inkjet head (10) mounted on a supporting member (20, 20₁, 20′, 20″, 200), said ink comprising a solvent that is liable to evaporate when it makes contact with the target surface; and
making evaporation of the solvent contained in the ink more rapid by way of a means (40) for setting a fluid extracted via at least one orifice (30, 31, . . . , 3ₙ, 30₁, 30₂, 30′, 30″) placed around the inkjet head (10) in motion.

13. The inkjet printing process as claimed in claim 12 in which the target surface (100) is heated.
